(19) United States
(12) Patent Application Publication
(10) Pub. No.: US 2017/0220431 A1
(43) Pub. Date: Aug. 3, 2017

(54) FAILOVER OF A DATABASE IN A HIGH-AVAILABILITY CLUSTER

(71) Applicant: International Business Machines Corporation, Armonk, NY (US)

(72) Inventors: Juilee A. Joshi, Pune (IN); Gaurav Mehrotra, Pune (IN); Nishant Sinha, Pune (IN); Jing Jing Xiao, Beijing (CN)

(21) Appl. No.: 15/011,700

(22) Filed: Feb. 1, 2016

(51) Int. Cl. G06F 11/20

(52) U.S. Cl. CPC G06F 11/2033; G06F 2201/80; G06F 2201/805

(57) ABSTRACT

As disclosed herein a computer-implemented method for managing an HA cluster includes activating, by a cluster manager, a monitoring process that monitors a database on a first node in a high-availability database cluster. The method further includes receiving an indication that the database on the first node is not healthy, initiating a failover operation for deactivating the database on the first node and activating a standby database on a second node in the high-availability database cluster providing an activated standby database, and ensuring that any additional databases on the first node are unaffected by the failover operation. A computer program product corresponding to the above method is also disclosed.

### BACKGROUND

The present invention relates to high-availability database clusters, and more particularly to failover of a single database within a high-availability database cluster.

In today's highly computerized world, the expectation is that computing environments and services will be available at all times (i.e., with 100% availability). One approach to providing high-availability is to use high-availability (HA) clusters. HA clusters operate by using high-availability software to manage a group of redundant computers (i.e., a cluster). The computers in the HA cluster use failover technology to provide continued service when system components within the cluster fail. HA clusters are often used for critical databases, file sharing on a network, business applications, and customer services such as electronic commerce websites.

### SUMMARY

As disclosed herein a computer-implemented method for managing an HA cluster includes activating, by a cluster manager, a monitoring process that monitors a database on a first node in a high-availability database cluster. The method further includes receiving an indication that the database on the first node is not healthy, initiating a failover operation for deactivating the database on the first node and activating a standby database on a second node in the high-availability database cluster providing an activated standby database, and ensuring that any additional databases on the first node are unaffected by the failover operation.

As disclosed herein a computer-implemented method for monitoring an HA database includes initializing a database consistency indicator to indicate that a database on a first node in a high-availability database cluster is healthy, and monitoring the database on the first node. The method further includes determining that the database on the first node is not healthy, and indicating that the database on the first node is not healthy.

As disclosed herein a computer program product for managing an HA cluster includes program instructions to perform activating, by a cluster manager, a monitoring process that monitors a database on a first node in a high-availability database cluster. The computer program product further includes instructions to perform receiving an indication that the database on the first node is not healthy, and initiating a failover operation for deactivating the database on the first node, activating a standby database on a second node in the high-availability database cluster providing an activated standby database, and ensuring that any additional databases on the first node are unaffected by the failover operation.

### BRIEF DESCRIPTION OF THE DRAWINGS

FIG. 1 is a functional block diagram depicting a computing environment, in accordance with at least one embodiment of the present invention;

FIG. 2 is a flowchart depicting an HA cluster manager control method, in accordance with at least one embodiment of the present invention;

FIG. 3 is a flowchart depicting an HA database monitoring method, in accordance with at least one embodiment of the present invention;

FIG. 4 is a data flow diagram depicting a database failover operation, in accordance with at least one embodiment of the present invention; and

FIG. 5 is a functional block diagram depicting various components of one embodiment of a computer suitable for executing the methods disclosed herein.

### DETAILED DESCRIPTION

The everyday life of society as a whole is becoming dependent on computing devices. Individuals use computers on a daily basis to manage and maintain many aspects of their lives. In general, we rely on computers to provide, for example, communication, entertainment, online banking, and online shopping applications. The expectation is that, regardless of the time of day, the application or service will be available.

Providing reliable computing environments is a high priority for service providers. Companies providing online services and applications may use high-availability (HA) clusters to increase or maintain availability of applications and services. An HA cluster may include a group of two or more servers (HA nodes), each capable of providing the same service to one or more clients. Some services requiring database access, use HA clusters to provide database services. In an HA cluster of two or more HA nodes, the workload for a given service will be directed to only one of the HA nodes (the primary HA node). If an active HA node, or a service provided by an active HA node fails, another node (a failover HA node) in the HA cluster may begin providing the services that failed on the primary HA node.

Without clustering, if a database service becomes unavailable (e.g., a database becomes corrupted or the server providing the service crashes), the service will be unavailable until the cause of the failure is determined and resolved. If the database service is provided by an HA clustered environment, and the database service on a primary HA node becomes inaccessible, then failover operations may enable a failover HA node within the HA cluster to continue providing the service that was initially being provided by the primary HA node.

In an HA clustered database environment, a monitor (e.g., a cluster manager) may be monitoring (analyzing) the health of the database environment (e.g., monitoring a database instance). In some implementations, there are multiple databases within the database instance. The monitor analyzes the health of a database instance, rather than the health of any specific database within the instance. As long as the instance continues to appear healthy, no failover will occur. However, if the instance experiences health issues, the monitor will initiate a failover operation. The failover operation may stop all databases in the database instance, stop the database instance, and start the failover instance and databases on the failover node.

Situations may arise where database services provided by an HA cluster become unavailable (e.g., a database within an instance is inaccessible). If the instance containing the inaccessible database continues to appear healthy, then no failover will occur and manual intervention may be required once the inaccessible database is discovered and reported. However, if the unhealthy database eventually causes the instance to experience health issues, the monitor will initiate a failover operation which will result in the services of all databases under the control of the database instance to be moved to the failover node. It has been observed that if the monitor were able to analyze the health of each individual database, then a failover operation could target only the unhealthy database and leave all other databases, services, and users unaffected.

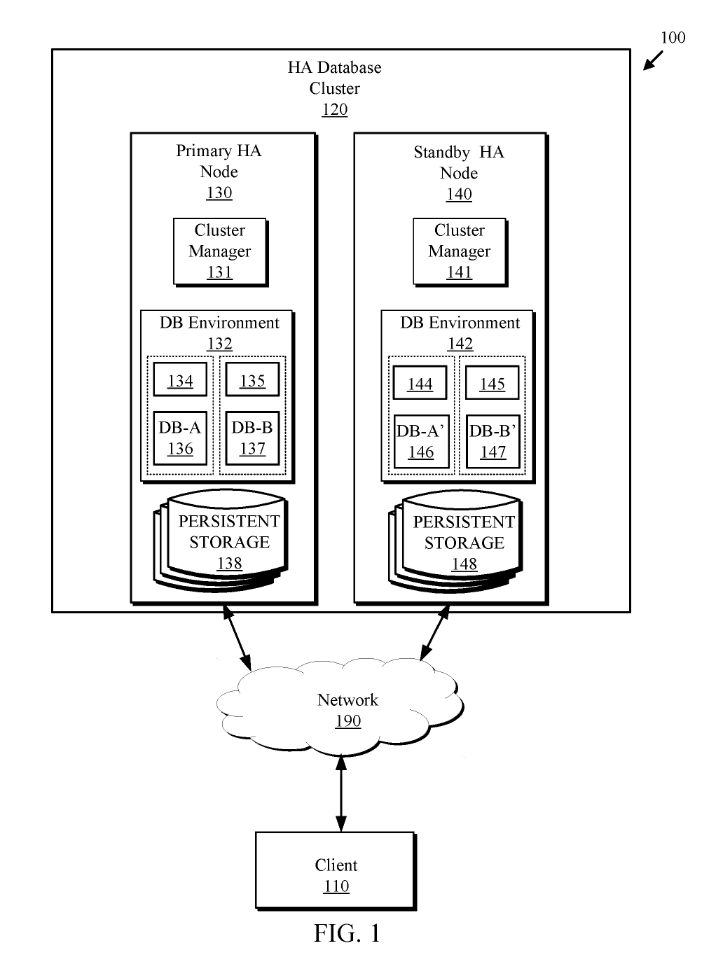

The present invention will now be described in detail with reference to the Figures. FIG. 1 is a functional block diagram depicting a computing environment 100, in accordance with an embodiment of the present invention. Computing environment 100 includes client 110 and HA database cluster 120. HA database cluster 120 may provide database services to client 110. The database services provided may be included as part of various online services, for example, online shopping, online banking, email, video streaming, music downloads, online gaming, or any other services capable of being provided over network 190. HA database cluster 120 includes redundant servers (primary HA node 130 and standby HA node 140) that are both configured to provide the database services offered by HA database cluster 120. Primary HA node 130 and standby HA node 140 may be web servers, mail servers, video servers, music servers, online gaming servers, or any other server known to those of skill in the art that are capable of supporting database installation and operations.

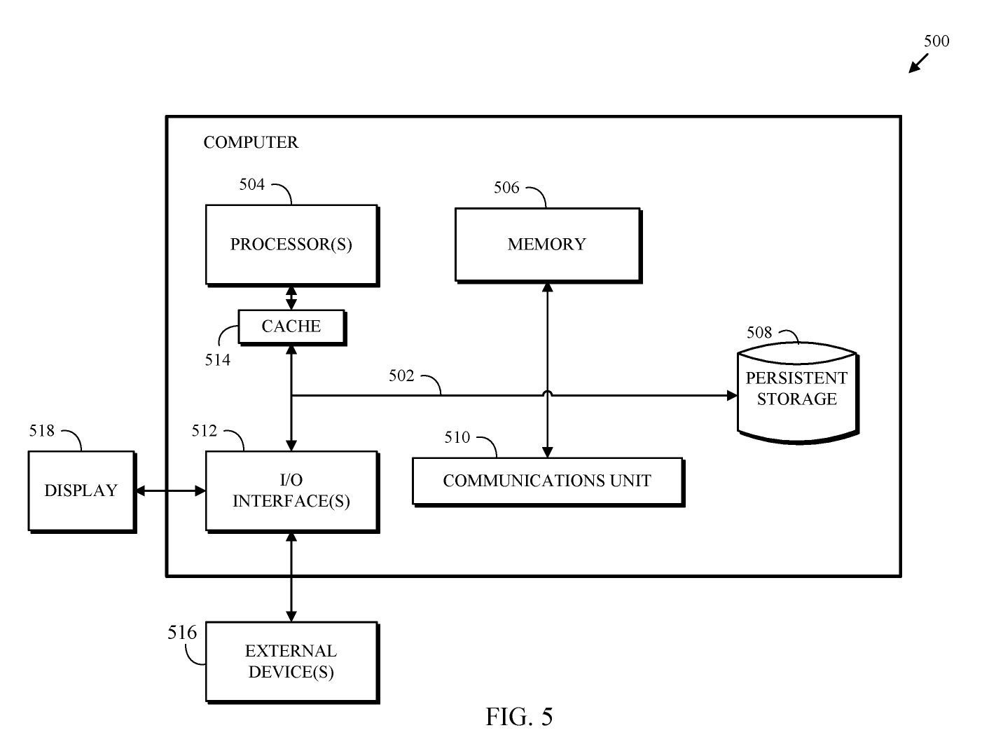

Client 110, primary HA node 130, and standby HA node 140 can include smart phones, tablets, desktop computers, laptop computers, specialized computer servers, or any other computer systems, known in the art, capable of communicating over network 190. In general, client 110, primary HA node 130, and standby HA node 140 maybe electronic devices, or combination of electronic devices, capable of executing machine-readable program instructions, as described in greater detail with regard to FIG. 5.

As depicted, primary HA node 130 includes cluster manager 131, database (DB) environment 132 and persistent storage 138. Database environment 132 (sometimes called an instance) may be a logical database manager environment where databases may be cataloged and configured. In some embodiments, more than one instance can be created on the same physical server (i.e., node) providing a unique database server environment for each instance. Database environment 132 may be, but is not limited to, a relational database, a database warehouse, or a distributed database.

As depicted, database environment 132 includes database A (DB-A) 136 and monitoring process 134, as well as, database B (DB-B) 137 and monitoring process 135. Monitoring process 134 may be initiated by cluster manager 131 to monitor the heath of DB-A 136 (e.g., is the database connectable). Likewise, monitoring process 135 may be initiated by cluster manager 131 to monitor the heath of DB-B 137. If monitoring process 134 detects that DB-A 136 is unhealthy, then monitoring process 134 may indicate to cluster manager 131 that DB-A is unhealthy (inaccessible). In some embodiments, monitoring process 134 indicates that DB-A 136 is inaccessible by updating a parameter corresponding to DB-A 136. In other embodiments, monitoring process 134 indicates that DB-A 136 is inaccessible by broadcasting an event indicating that 136 is inaccessible.

In some embodiments, the databases are accessed by client 110 using virtual IP (VIP) addresses. A VIP is an internet protocol (IP) address that doesn't correspond to an actual physical network interface (port), enabling the endpoint of the VIP to be altered (re-mapped) to a standby database during a failover operation. Use of VIPs may enable client 110 to access data in HA database cluster 120 without requiring client 110 to be aware of which HA node (primary HA node 130 or standby HA node 140) is actually providing the service.

When cluster manager 131 receives an indication that a database (e.g., DB-A 136) is inaccessible, cluster manager 131 may initiate a failover operation. In some embodiments, all failover operations are initiated by a master cluster manager. If cluster manager 131 is the master cluster manager (not shown), then cluster manager 131 directly initiates a failover operation. If cluster manager 131 is not the master cluster manager, then cluster manager 131 communicates the failover request to the master cluster manager and the master cluster manager initiates a failover operation. In some embodiments, a failover operation may be initiated by any cluster manager that discovers a database is inaccessible.

Standby HA node 140 is a redundant server, capable of providing the same database services as primary HA node 130. As depicted, standby HA node 140 includes standby cluster manager 141, database environment 142, and persistent storage 148. Database environment 142 includes database A (DB-A′) 146 and monitoring process 144, as well as, database B (DB-B′) 148 and monitoring process 145. The data corresponding to databases DB-A 136 and DB-B 137 is stored on persistent storage 138. Data corresponding to the redundant databases DB-A′ 146 and DB-B′ 147 is stored on persistent storage 148. The data is kept in synch between the two nodes using techniques familiar to those of skill in the art (e.g., replaying logs from DB-A 136 on DB-A′ 146.

When a database is determined to be inaccessible (e.g., monitoring process 134 cannot connect to DB-A 136), a master cluster manager (cluster manager 131 in this example) may initiate a failover operation. The failover operation may include: (i) re-mapping the VIP to use DB-A′ 146 on standby HA node 140; (ii) ensuring that DB-A 136 is stopped on primary HA node 130; (iii) ensuring that DB-A′ 146 is active; and (iv) making DB-A′ 146 the new primary database. After the failover operation has completed, DB-A′ 146 on standby HA node 140 will have assumed the primary role and DB-A 136 on primary HA node 130 will be inactive. In some embodiments, when the issue causing DB-A 136 to be inaccessible is resolved, DB-A 136 will become available as a standby database. In other embodiments, when the issue causing DB-A 136 to be inaccessible is resolved, the failover operation is reversed, causing DB-A 136 to re-assume the active database role and DB-A′ 146 to re-assume the standby database role.

In some embodiments, primary HA node 130 and standby HA node 140 are located proximate to each other (e.g., in the same data center). In other embodiments, primary HA node 130 and standby HA node 140 are remotely located from each other. Primary HA node 130 and standby HA node 140 each include persistent storage (e.g., persistent storage 138 and 148). In the depicted embodiment, primary HA node 130 and standby HA node 140 each include separate persistent storage. In other embodiments, primary HA node 130 and standby HA node 140 access shared network attached storage. In another embodiment, primary HA node 130 and standby HA node 140 access shared storage that is procured from a cloud service.

Client 110 may be any client that communicates with HA database cluster 120 over network 190. Client 110 may wish to use services provided by HA database cluster 120. Client 110 may use online services such as an online banking service, computational services, or analytical services that use the database services provided by HA database cluster 120. In the depicted embodiment, client 110 is separated from HA database cluster 120. In other embodiments, client 110 is also a server within HA database cluster 120 such that client 110 and primary HA node 130 coexist on a single computer. Client 110, primary HA node 130, and standby HA node 140 may be procured from a cloud environment.

Persistent storage 138 and 148 may be any non-volatile storage device or media known in the art. For example, persistent storage 138 and 148 can be implemented with a tape library, optical library, solid state storage, one or more independent hard disk drives, or multiple hard disk drives in a redundant array of independent disks (RAID). Similarly, data on persistent storage 138 and 148 may conform to any suitable storage architecture known in the art, such as a file, a relational database, an object-oriented database, and/or one or more tables.

Client 110, primary HA node 130, standby HA node 140, and other electronic devices (not shown) communicate over network 190. Network 190 can be, for example, a local area network (LAN), a wide area network (WAN) such as the Internet, or a combination of the two, and include wired, wireless, or fiber optic connections. In general, network 190 can be any combination of connections and protocols that will support communications between client 110 and HA database cluster 120 in accordance with an embodiment of the present invention.

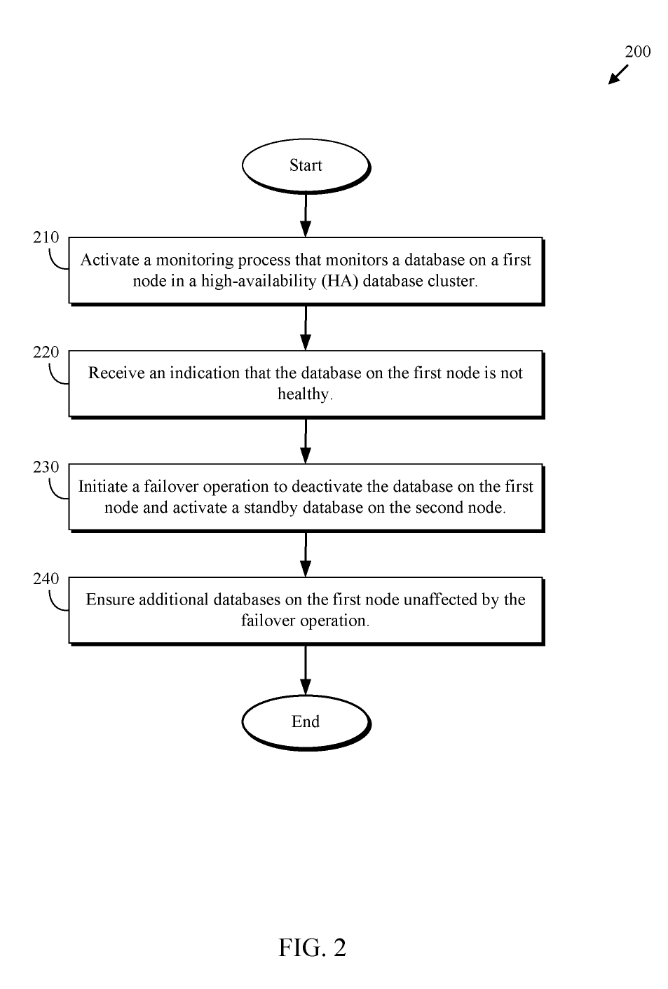

FIG. 2 is a flowchart depicting HA cluster manager control method 200, in accordance with at least one embodiment of the present invention. As depicted, HA cluster manager control method 200 includes activating (210) a monitoring process, receiving (220) an indication that a database is not healthy, initiating (230) a failover operation, and ensuring (240) that additional databases are unaffected by the failover operation. As depicted, HA cluster manager control method 200 initiates a monitoring operation corresponding to an individual HA database, and initiates a failover operation if a monitored database is determined to be inaccessible.

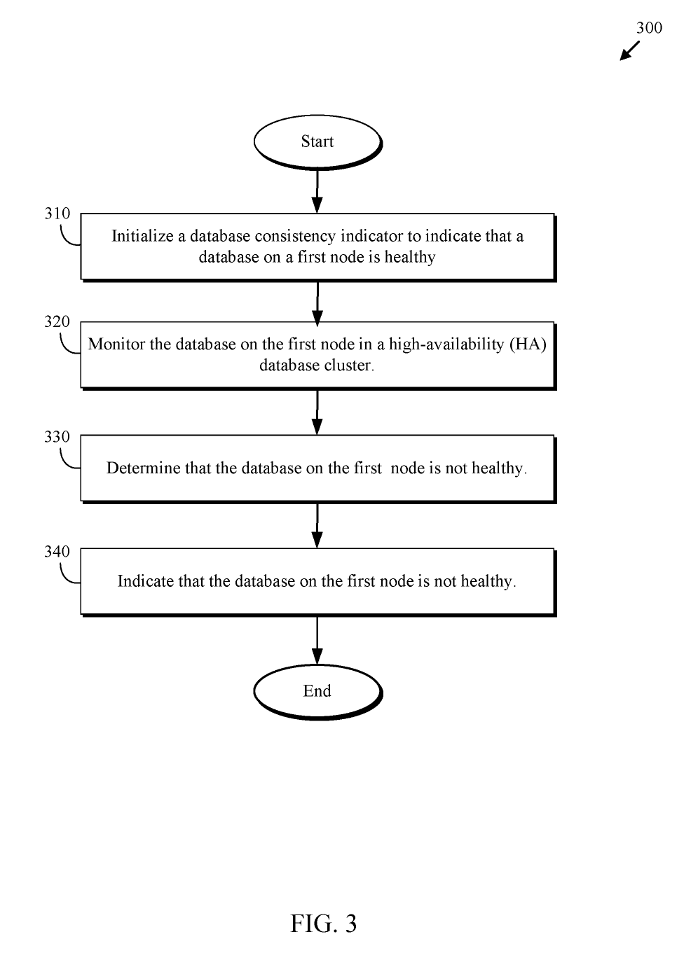

Activating (210) a monitoring process may include a cluster manager (e.g., cluster manager 131) initiating an operation (e.g., monitoring process 134) that monitors a database (e.g., DB-A 136) on a first node (e.g., primary HA node 130) in a high-availability database cluster (e.g., HA database cluster 120). Each monitoring process may only monitor a single database. In some embodiments, database DB-A 136 is started as part of the activation operation. In other embodiments, database DB-A 136 is started upon the first connection request from client 110. In some embodiments, monitoring process 134 is enabled, but only begins monitoring database accessibility once the first database connection request is detected. The operation of monitoring process 134 will be described in greater detail with regard to FIG. 3. In some embodiments, the first activation request from cluster manager 131 includes starting (making operational) the instance (e.g., DB environment 132). In other embodiments, the instance (e.g., DB environment 132) is operational prior to the first activation request from cluster manager 131.

Receiving (220) an indication that a database is not healthy may include a cluster manager (e.g., cluster manager 131) receiving an indication from a monitoring operation (e.g., monitoring process 134) that a database (e.g., DB-A 136) is inaccessible. In some embodiments, monitoring process 134 monitors a database consistency indicator that indicates the health of database DB-A 136. If database DB-A 136 is in an unhealthy state, then the value of the database consistency indicator may be altered to indicate database DB-A 136 is unhealthy and a failover operation is necessary. In other embodiments, monitoring process 134 communicates directly with cluster manager 131 (e.g., using an alert such as a signal or message) to indicate that database DB-A 136 is unhealthy and a failover operation is necessary.

In some embodiments, cluster manager 131 is not a master cluster manager. In the depicted embodiment, cluster manager 131 indicates to the master cluster manager that DB-A 136 is inaccessible (unhealthy) and that a failover operation should be initiated. In other embodiments, cluster manager 131 is the master cluster manager and receives from other non-master cluster managers an indication that a database on another HA node within HA database cluster 120 is inaccessible.

Initiating (230) a failover operation may include a cluster manager (e.g., cluster manager 131) determining which standby node (e.g., standby HA node 140) contains the appropriate standby database. The appropriate standby node may be determined using techniques familiar to those of skill in the art. Initiating the failover operation may also include deactivating the inaccessible database (e.g., DB-A 136) on a first node (e.g., primary HA node 130) and activating a standby database (e.g., DB-A′ 146) on a second node (i.e., standby HA node 140). Deactivating the inaccessible database may include ensuring that the inaccessible database on the first node is stopped, and redirecting the network traffic to the standby database. In some embodiments, redirecting the network traffic includes remapping Virtual IP (VIP) addresses such that the VIP is remapped to the standby database (e.g., DB-A′ 146). In other embodiments, redirecting the network traffic includes use of proxy server rules and load balancers to redirect the network traffic to the standby database (e.g., DB-A′ 146). Activating a standby database may include confirming that the database on the second node has been started, assigning the standby database the primary role, and assigning the inaccessible database the standby role. A database may assume the primary role when a VIP is assigned (mapped) to the database, causing network traffic to be delivered to the database.

Ensuring (240) that additional databases are unaffected by the failover operation may include a cluster manager (e.g., cluster manager 131) performing a failover operation on only the failed database (e.g., DB-A 136) and allowing any remaining accessible databases (e.g., DB-B 137) to continue operating on the first node (e.g., primary HA node 130). The failover operation should only affect (restore) services provided by the inaccessible database (e.g., DB-A 136). Any additional databases (e.g., database DB-B 137) within the same instance (e.g., DB environment 132) as DB-A 136 should remain unaffected, and continue running in database environment 132, ensuring uninterrupted service to any connected clients.

FIG. 3 is a flowchart depicting HA database monitoring method 300, in accordance with at least one embodiment of the present invention. As depicted, HA database monitoring method 300 includes initializing (310) a database consistency indicator, monitoring (320) a database, determining (330) whether a database is not healthy, and indicating (340) that the database is not healthy. As depicted, HA database monitoring method 300 enables monitoring of individual databases within an HA clustered environment to detect when a database is inaccessible.

Initializing (310) a database consistency indicator may include a monitoring process (e.g., monitoring process 134) assigning a value to the database consistency indicator that indicates whether the database being monitored (e.g., DB-A 136) by monitoring process 134 is configured for HA and is currently operating successfully. In some embodiments, the database consistency indicator is maintained on persistent storage (e.g., persistent storage 138). In other embodiments, the database consistency indicator is maintained in a computer memory component such as random access memory (RAM).

In some embodiments, the database consistency indicator of an HA environment is a database configuration parameter with three possible values (e.g., ‘TRUE’, ‘FALSE’, and ‘OFF’). A database consistency indicator with a value of ‘TRUE’ may indicate that the database (e.g., DB-A 136) is configured for an HA environment, and that the monitoring process (e.g., monitoring process 134) should continue to monitor the health of database DB-A 136. A database consistency indicator with a value of ‘FALSE’ may indicate that the database (e.g., DB-A 136) is not healthy and failover operations should be initiated. A database consistency indicator with a value of ‘OFF’ may indicate that the database (e.g., DB-A 136) should not be monitored. The ‘OFF’ value may be used to indicate that database DB-A 136 is not configured for an HA environment. Alternatively, the ‘OFF’ value may indicate that database DB-A 136 has become unhealthy, and a failover operation has disabled database DB-A 136 and enabled a standby database (e.g., DB-A′ 146).

Monitoring (320) a database may include a monitoring process (e.g., monitoring process 134) repeatedly (over very short intervals) analyzing the health of a database (e.g., DB-A 136). Monitoring process 134 may use a combination of one or more monitoring operations to determine if database DB-A 136 is healthy. For example, monitoring process 134 may: (i) attempt to obtain a connection to database DB-A 136; (ii) listen for a transmission (e.g., a “heartbeat”) from database DB-A 136 that indicates database DB-A 136 is alive and operational; (iii) monitor memory usage by database DB-A 136; and/or (iv) listen for, and intercept communications between database DB-A 136 and cluster manager 131 that indicate that DB-A 136 is unhealthy. This is only an exemplary list and is not intended to be complete or limiting.

Determining (330) whether a database is not healthy may include a monitoring process (e.g., monitoring process 134) detecting a failure during the monitoring (320) operation. If monitoring process 134 is unable to connect to database DB-A 136, then monitoring process 134 may determine that database DB-A 136 is inaccessible. If monitoring process 134 does not receive a heartbeat transmission from database DB-A 136 over a selected duration, then monitoring process 134 may determine that database DB-A 136 is unhealthy. If monitoring process 134 detects that memory pools corresponding to database DB-A 136 are not in use, then monitoring process 134 may determine that database DB-A 136 is unhealthy. Additionally, monitoring process 134 may intercept communications (e.g., alerts such as signals or messages) targeted for cluster manager 131 indicating there are problems with the database. By intercepting the alerts, monitoring process 134 may determine that database DB-A 136 is unhealthy.

Indicating (340) that the database is not healthy may include a monitoring process (e.g., monitoring process 134) informing cluster manager 131 that database DB-A 136 is unhealthy. In some embodiments, monitoring process 134 sets a database consistency indicator to a value of ‘FALSE’ to inform cluster manager 131 that database DB-A 136 is unhealthy and a failover operation is necessary. In other embodiments, monitoring process 134 communicates directly with cluster manager 131 (e.g., using an alert such as a signal or message) to indicate that database DB-A 136 is unhealthy and a failover operation is necessary. In some embodiments, monitoring process 134 communicates directly with the master cluster manager which may or may not be cluster manager 131.

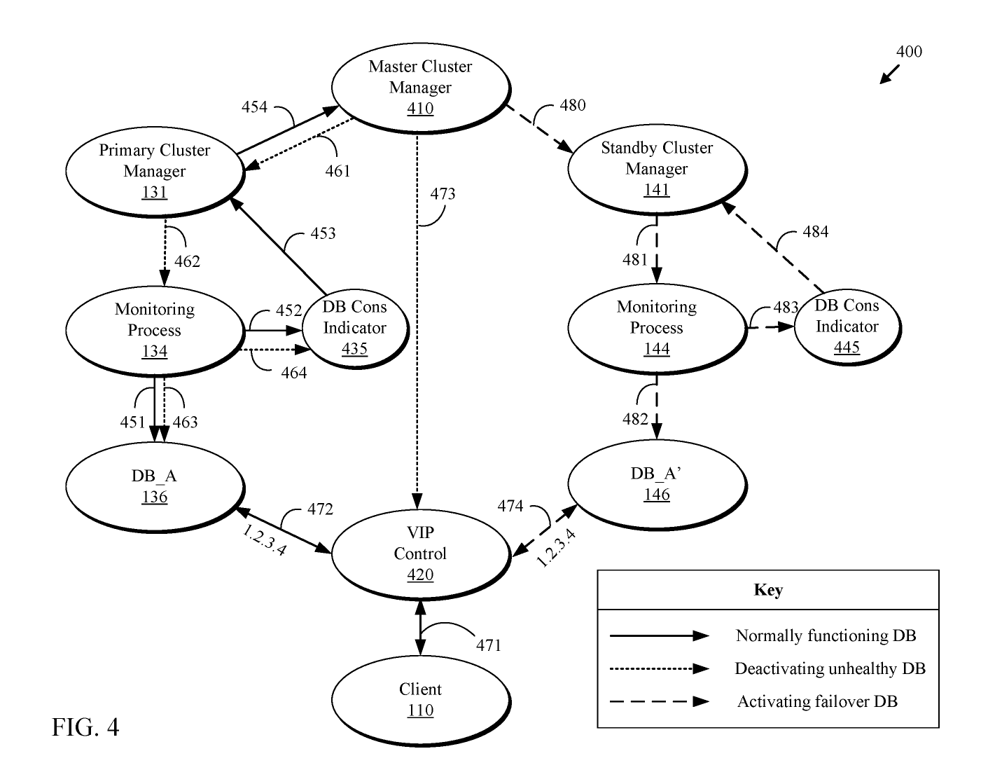

FIG. 4 is a data flow diagram 400 depicting a database failover operation, in accordance with at least one embodiment of the present invention. As depicted, data flow diagram 400 includes a currently active HA database node comprising primary cluster manager 131, monitoring process 134, database DB_A 136, and database consistency indicator 435. Data flow diagram 400 also includes a standby HA node comprising standby cluster manager 141, monitoring process 144, database DB_A′ 146, and database consistency indicator 445. In the depicted example, during normal operations, client 110 connects to database DB_A 136 using IP address 1.2.3.4 (flows 471 and 472). In some embodiments, IP address 1.2.3.4 is an IP address that is connected (e.g., mapped) to a specific device (database DB_A 136 in this example). In other embodiments, IP address 1.2.3.4 is a virtual IP (VIP) address, and the device to which IP address 1.2.3.4 is connected (e.g., mapped) is controlled by VIP control 420.

During normal operations, the health of database DB_A 136 is analyzed by monitoring process 134. To determine if database DB_A 136 is healthy, monitoring process 134 may repeatedly (according to a selected connection schedule, for example once every 10 seconds) attempt to connect to database DB_A 136 (flow 451). If monitoring process 134 is unable to successfully connect to database DB_A 136, then monitoring process 134 may determine that database DB_A 136 is inaccessible. In some embodiments, monitoring process 134 determines that database DB_A 136 is unhealthy after one failed connection attempt. In other embodiments, monitoring process 134 determines that database DB_A 136 is unhealthy after a selected (e.g., predetermined) number of consecutive failed connection attempts.

Upon determining that database DB_A 136 is unhealthy, monitoring process 134 may indicate to primary cluster manager 131 that database DB_A 136 is unhealthy. In the depicted example, monitoring process 134 may update DB consistency indicator 435 with a value that indicates that database DB_A 136 is unhealthy (flow 452). In some embodiments, monitoring process 134 modifies DB consistency indicator 435 from a value of ‘TRUE’ (indicating that database DB_A 136 is healthy) to a value of ‘FALSE’ (indicating that database DB_A 136 is unhealthy).

Primary cluster manager 131 may repeatedly monitor DB consistency indicator 435 to detect when database DB_A 136 becomes unhealthy, and if database DB_A 136 becomes unhealthy primary cluster manager 131 may indicate that a failover operation is necessary (flow 453). In some embodiments, cluster manager 131 repeatedly checks DB consistency indicator 435 to detect a change in the assigned value. In other embodiments, an alert is generated when the value of DB consistency indicator 435 is altered. Primary cluster manager 131 may receive the alert from DB consistency indicator 435 (flow 453). Upon receiving an indication that database DB_A 136 is unhealthy, cluster manager 131 communicates to master cluster manager 410 a need to initiate a failover operation for database DB_A 136 (flow 454).

Master cluster manager 410 initiates the failover operation (flow 461) which may include [i] stopping monitoring process 134 (flow 462); [ii] ensuring that database DB_A 136 is no longer running (flow 463); [iii] modifying DB consistency indicator 435 (flow 464) to a value of ‘OFF’ to indicate database DB_A 136 should not be monitored; [iv] assigning (remapping) VIP 1.2.3.4 from database DB_A 136 to database DB_A′ 146 (flow 473); and [v] informing standby cluster manager 141 to prepare database DB_A′ to assume the role of primary database (flow 480). In some embodiments, primary cluster manager 131 may be the master cluster manager and therefore communicates directly with VIP control 410 and standby cluster manager 141. In some embodiments, cluster manager 410 monitors operations of an individual HA node (not shown), in addition to controlling failover operations for all nodes within an HA database cluster (e.g., HA database cluster 120).

During the failover operation, standby cluster manager 141 may confirm that monitoring process 144 is operational (flow 481). In some embodiments, monitoring process 144 is running prior to a failover operation. In other embodiments, monitoring process 144 is not running and must be initialized by standby cluster manager 141. Monitoring process 144 may also confirm that database DB_A′ 146 is up and operational (flow 482). In some embodiments, database DB_A′ 146 is up and ready for operation. In other embodiments, database DB_A′ 146 is up, but in standby mode and must be made operational by monitoring process 144. In some other embodiments, database DB_A′ 146 is not up and must be started by monitoring process 144 to be operational. Additionally, monitoring process 144 may modify the value of DB consistency indicator 455 to a value of ‘TRUE’ (flow 483) to inform standby cluster manager 141 that database DB_A′ is currently being monitored and is healthy.

After the failover operation has completed, all connection requests for database DB_A 136 (via VIP 1.2.3.4) will be transparently directed to database DB_A′ 146 (flow 474). At the beginning of the present example, client 110 was using the services of database DB_A 136 via VIP 1.2.3.4 (flows 471 and 472). After the failover operation as described herein, client 110 is unaware that the requested database services are now being provided by database DB_A′ 146 (flows 471 and 474). Only the operation of database DB_A 136 was affected by the failover operation. Any additional databases that may be operating under cluster manager 131 have not been affected and continue to operate as they were prior to the failover operation corresponding to database DB_A 136 becoming unhealthy.

FIG. 5 depicts a functional block diagram of components of a computer system 500, which is an example of systems such as client 110, primary HA node 130, and standby HA node 140 within computing environment 100 of FIG. 1, in accordance with an embodiment of the present invention. It should be appreciated that FIG. 5 provides only an illustration of one implementation and does not imply any limitations with regard to the environments in which different embodiments can be implemented. Many modifications to the depicted environment can be made.

Client 110, primary HA node 130, and standby HA node 140 include processor(s) 504, cache 514, memory 506, persistent storage 508, communications unit 510, input/output (I/O) interface(s) 512 and communications fabric 502. Communications fabric 502 provides communications between cache 514, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM). In general, memory 506 can include any suitable volatile or non-volatile computer readable storage media. Cache 514 is a fast memory that enhances the performance of processor(s) 504 by holding recently accessed data, and data near recently accessed data, from memory 506.

Program instructions and data used to practice embodiments of the present invention, e.g., HA cluster manager control method 200 and HA database monitoring method 300 are stored in persistent storage 508 for execution and/or access by one or more of the respective processor(s) 504 via cache 514. In this embodiment, persistent storage 508 includes a magnetic hard disk drive. Alternatively, or in addition to a magnetic hard disk drive, persistent storage 508 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of client 110, primary HA node 130, and standby HA node 140. In these examples, communications unit 510 includes one or more network interface cards. Communications unit 510 may provide communications through the use of either or both physical and wireless communications links. Program instructions and data used to practice embodiments of HA cluster manager control method 200 and HA database monitoring method 300 may be downloaded to persistent storage 508 through communications unit 510.

I/O interface(s) 512 allows for input and output of data with other devices that may be connected to each computer system. For example, I/O interface(s) 512 may provide a connection to external device(s) 516 such as a keyboard, a keypad, a touch screen, a microphone, a digital camera, and/or some other suitable input device. External device(s) 516 can also include portable computer readable storage media such as, for example, thumb drives, portable optical or magnetic disks, and memory cards. Software and data used to practice embodiments of the present invention can be stored on such portable computer readable storage media and can be loaded onto persistent storage 508 via I/O interface(s) 512. I/O interface(s) 512 also connect to a display 518.

Display 518 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for managing an HA cluster, executed by one or more processors, the method comprising:
activating, by a cluster manager, a monitoring process that monitors a database on a first node in a high-availability database cluster;
receiving an indication that the database on the first node is not healthy; and
initiating a failover operation for deactivating the database on the first node, activating a standby database on a second node in the high-availability database cluster to provide an activated standby database, and ensuring that any additional databases on the first node are unaffected by the failover operation.

2. The method of claim 1, wherein the cluster manager is a master cluster manager that monitors all databases included in the high-availability database cluster.

3. The method of claim 1, further comprising using a virtual IP address to redirect network traffic to the activated standby database.

4. The method of claim 1, wherein the database is part of an instance, and the instance includes one or more databases.

5. The method of claim 4, wherein deactivating the database on the first node includes ensuring that the database on the first node is stopped and remapping a virtual IP address to the standby database.

6. The method of claim 4, wherein activating the standby database on the second node includes making the standby database a new primary database.

7. The method of claim 1, wherein receiving the indication that the database on the first node is not healthy includes detecting that a database consistency indicator has been updated to indicate that the database on the first node is not healthy.

8. The method of claim 1, wherein receiving the indication that the database on the first node is not healthy includes receiving an alert that indicates that the database on the first node is not healthy.

9. A method for monitoring an HA database, executed by one or more processors, the method comprising:
initializing a database consistency indicator to indicate that a database on a first node in a high-availability database cluster is healthy;
monitoring the database on the first node;
determining that the database on the first node is not healthy; and
indicating that the database on the first node is not healthy.

10. The method of claim 9, wherein monitoring comprises connecting to the database.

11. The method of claim 9, wherein monitoring comprises intercepting alerts that indicate the database is unable to function properly.

12. The method of claim 9, wherein monitoring comprises confirming that database memory pools corresponding to the database are in use.

13. The method of claim 9, further comprising updating the database consistency indicator to indicate that the database on the first node is not healthy.

14. A computer program product comprising:
one or more computer readable storage media and program instructions stored on the one or more computer readable storage media, the program instructions comprising instructions executable by a computer to perform:
activating, by a cluster manager, a monitoring process that monitors a database on a first node in a high-availability database cluster;
receiving an indication that the database on the first node is not healthy; and
initiating a failover operation for deactivating the database on the first node, activating a standby database on a second node in the high-availability database cluster to provide an activated standby database, and ensuring that any additional databases on the first node are unaffected by the failover operation.

15. The computer program product of claim 14, wherein the cluster manager is a master cluster manager that monitors all databases included in the high-availability database cluster.

16. The computer program product of claim 14, where in the program instructions include instructions to use a virtual IP address to redirect network traffic to the activated standby database.

17. The computer program product of claim 14, wherein the database is part of an instance, and the instance includes one or more databases.

18. The computer program product of claim 17, wherein the program instructions to deactivate the database on the first node includes include instructions to ensure the database on the first node is stopped and to remap a virtual IP address to the standby database.

19. The computer program product of claim 17, wherein the program instructions to activate the standby database on the second node include instructions to make the standby database a new primary database.

20. The computer program product of claim 14, wherein the program instructions to receive the indication that the database on the first node is not healthy includes instructions to detect that a database consistency indicator has been updated to indicate that the database on the first node is not healthy.
